(19) United States
(12) Patent Application Publication
(10) Pub. No.: US 2013/0346038 A1
(43) Pub. Date: Dec. 26, 2013

(54) METHOD AND DEVICE FOR CREATING COMPUTATIONAL MODELS FOR NONLINEAR MODELS OF POSITION ENCODERS

(71) Applicants: Alexandre WAGNER, Stuttgart (DE); Ralf BUEHRLE, Hochberg (DE)

(72) Inventors: Alexandre WAGNER, Stuttgart (DE); Ralf BUEHRLE, Hochberg (DE)

(73) Assignee: ROBERT BOSCH GMBH, Stuttgart (DE)

(21) Appl. No.: 13/909,646

(22) Filed: Jun. 4, 2013

(30) Foreign Application Priority Data
Jun. 4, 2012 (DE) 10 2012 209 374.5

(51) Int. Cl. G06F 17/50

(52) U.S. Cl. CPC G06F 17/5009
USPC 703/2; 700/29

(57) ABSTRACT

A method is described for ascertaining a computational model for a position encoder system, in particular for a position encoder for controlling a gas mass flow rate for an internal combustion engine, having the following steps: providing a differential equation system with at least one nonlinear term; dividing the differential equation system to obtain a linear part which is describable by a linear differential equation and a nonlinear part which is describable by a nonlinear differential equation; discretizing the linear part of the differential equation system with the aid of a first discretization method to obtain a computational model for the discretized linear part; discretizing the nonlinear part of the differential equation system with the aid of a second discretization method to obtain a computational model for the discretized nonlinear part; combining the computational models of the discretized linear part and the discretized nonlinear part of the differential equation system to obtain the computational model for the position encoder system.

### FIELD OF THE INVENTION

The present invention relates to methods for creating a computational model for a physical system, in particular for a position encoder for controlling a gas mass flow rate in an engine system.

### BACKGROUND INFORMATION

For designing controllers for regulating mechatronic actuator systems, such as, for example, position encoders for throttle valves in internal combustion engines and for their computational simulation, differential equation systems are usually created to map their physical behavior. Despite the use of simplified functions for mapping friction or the like, these differential equation systems are not linear.

In addition, a special challenge is unsteadiness such as that in nonlinear spring characteristic lines of return springs or the like, for example, i.e., return springs having different characteristics in different areas; so far it has been possible only with great difficulty to map such unsteadiness in the underlying differential equation system.

Furthermore, the equations must be discretized in time for the calculation to obtain a computational model. This discretization often results in equations systems that cannot be solved mathematically and therefore must be solved iteratively, i.e., usually in a very time-consuming procedure. This is often impractical for use in real time since control units for internal combustion engines, for example, have only a limited computing capacity.

Another requirement of the computational model which maps the physical system is adequate precision, since otherwise undesirable effects such as vibrations during regulations or misdiagnoses may occur when using the computational model for diagnostic purposes.

Nonlinear equations describing a physical system often cannot be discretized in a stable manner using conventional explicit discretization methods. Simplifications are therefore made frequently to minimize the computing effort in the control unit. For example, a simple friction model is used as the basis, or the inductance of an actuator drive is disregarded.

U.S. Pat. No. 6,668,214 describes an adaptive regulation with the aid of a model taking into account a dead time, whereby the friction and inductance of a position encoder drive are to be replaced.

The publication by S. Kopf et al., “Automatic model-based controller design for an electronic throttle,” TU Darmstadt and IAV, AAC 2010, Munich, uses a simple dynamic friction model for modeling a position encoder system.

A position encoder having a simple model which is easily discretizable is described in the publication by Z. Rem et al., “On methods for automatic modeling of dynamic systems with friction and their application to electromechanical throttles,” 49^{th} IEEE Conference on Decision and Control, Dec. 15 to 17, 2010. However, the inductance is again disregarded here and return springs are assumed to be simple return springs.

An implicit discretization of an air system model is described in German Published Patent Application No. 10 2008 043 965.

### SUMMARY

A method for creating a computational model for nonlinear models of a position encoder system and a device, an engine system, a computer program and a computer program product are provided according to the present invention.

According to a first aspect, a method for ascertaining a computational model for a position encoder system, in particular for a position encoder for controlling a gas mass flow rate for an internal combustion engine, is provided. This method includes the following steps:
providing a differential equation system with at least one nonlinear term;
dividing the differential equation system to obtain a linear part which is describable by a linear differential equation and a nonlinear part which is describable by a nonlinear differential equation;
discretizing the linear part of the differential equation system with the aid of a first discretization method to obtain a computational model for the discretized linear part;
discretizing the nonlinear part of the differential equation system with the aid of a second discretization method;
combining the computational models of the discretized linear part and the discretized nonlinear part of the differential equation system to obtain the computational model for the position encoder system.

One idea of the above method is preferably not to simplify the differential equation model mapping the physical model and to divide it into a linear part and a nonlinear part. The linear part and the nonlinear part may then be solved separately from one another. This also permits discretization of physical models without simplification and implementation thereof in control units having a limited computing capacity. Use of non-simplified models has the advantage that the risk of oscillations and diagnostic inaccuracies may be reduced.

In addition, the nonlinear term of the differential equation system may be brought about by a friction and static friction behavior of an actuator of the position encoder and/or by a nonsteady characteristic line of a component of the position encoder system.

It is also possible to provide that the first discretization method corresponds to Tustin's method and/or the second discretization method corresponds to an implicit method, in particular an implicit Euler method.

According to one specific exemplary embodiment, the first discretization method may correspond to Tustin's method, a leading in the computational model for the discretized linear part resulting from Tustin's method being compensated by taking into account a delay of dT/2.

It may be provided that the obtained computational model for the position encoder system is solved by an iterative method.

An interval in which the solution of the computational model for the position encoder system is situated may be determined, the obtained computational model for the position encoder system being solved by an iterative method within the interval.

According to another aspect, a device, in particular an arithmetic unit, is provided for ascertaining a computational model for a position encoder system, in particular for a position encoder for controlling a gas mass flow rate for an internal combustion engine, this device being designed:
to provide a differential equation system having at least one nonlinear term;
to divide a differential equation system to obtain a linear part which is describable by a linear differential equation and a nonlinear part which is describable by a nonlinear differential equation;
to discretize the linear part of the differential equation system with the aid of a first discretization method to obtain a computational model for the discretized linear part;
to discretize the nonlinear part of the differential equation system with the aid of a second discretization method;
to combine the computational models of the discretized linear part and of the discretized nonlinear part of the differential equation system to obtain the computational model for the position encoder system.

According to another aspect, an engine system having an internal combustion engine, a position encoder system for adjusting a gas mass flow rate and a control unit is provided, a computational model for the position encoder system which has been ascertained according to the above method being used in the control unit.

According to another aspect, a computer program having program code means is provided for carrying out all steps of the above method when the computer program is executed on a computer or an appropriate arithmetic unit, in particular in the above device.

According to another aspect, a computer program product is provided, containing a program code which is stored on a computer-readable data medium and which, when executed on a data processing system, carries out the above method.

### BRIEF DESCRIPTION OF THE DRAWINGS

FIG. 1 shows a schematic diagram of a throttle valve position encoder as the physical system to be modeled.

FIG. 2 shows a flow chart to illustrate the method for creating a computational model for mapping the behavior of the physical model of FIG. 1.

FIG. 3 shows a diagram to illustrate a spring characteristic line for a return spring of the position encoder system of FIG. 1.

### DETAILED DESCRIPTION

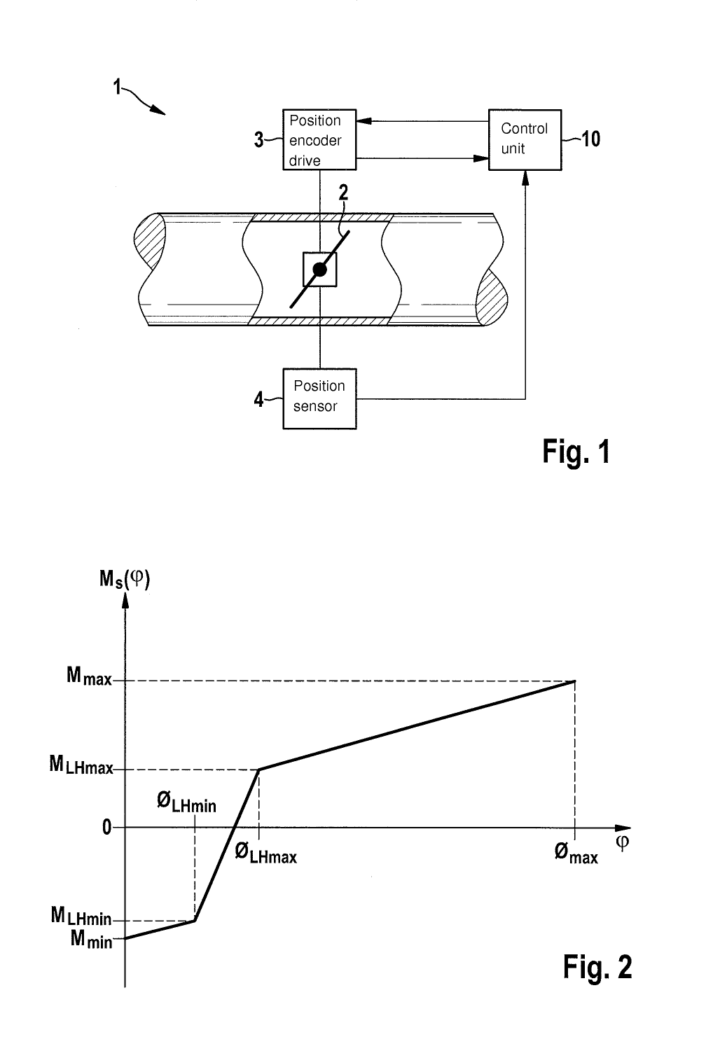

FIG. 1 shows a position encoder system 1 for adjusting the position of an actuator 2. This method for creating a computational model which maps the physical model of position encoder system 1 as accurately as possible and makes it suitable for use in a control unit having a limited computing capacity, for example, is described below on the basis of a throttle valve position encoder, which is able to adjust a throttle valve as actuator 2. However, it is also possible to apply the method described below to other position encoder systems whose physical behavior is describable by nonlinear differential equations.

Actuator 2 is moved with the aid of a position encoder drive 3. Position encoder drive 3 may be designed as an electromechanical actuator, which may be designed, for example, as a dc motor, as an electronically commutated motor or as a stepping motor. With the aid of a position sensor 4, the position actually assumed by actuator 2 may be detected and analyzed.

Position encoder drive 3 is triggered by a control unit 10 to approach a certain position of actuator 2. To carry out a position regulation for actuator 2, control unit 10 receives an acknowledgment from position sensor 4 regarding the actual position of actuator 2 as well as an indication about an actuating torque, for example, an indication about the current consumed by position encoder drive 3.

In particular when using an observer model for the position regulation but also for diagnosis of the position regulation, a computational model for physical position encoder system 1 may be implemented in control unit 10. For example, the actuation speed of position encoder system 1 may also be calculated using a computational model if the resolution of the position signal supplied by position sensor 4 is too low for a derivation. Furthermore, for operation of the overall system in sensitive areas in particular, it may necessary to monitor the function of position encoder system 1 by carrying out a plausibility check of the function of position encoder system 1 with the aid of the computational model.

For modeling of above position encoder system 1 the following equations are used:

U=RI+Lİ+CₘK_{gear}\dot{φ}

J\ddot{φ}=CₘK_{gear}I−Mₛ(φ)−M_{f}(\ddot{φ})−A(pₚᵣₑ−pₚₒₛₜ)

where variable R corresponds to an effective resistance, i.e., the sum of the winding resistance of electromechanical position encoder drive 3, the line connections and the resistance of the output stage, L corresponds to an inductance of a winding of electromechanical position encoder drive 3, I corresponds to a position encoder current through position encoder drive 3 and Cₘ is an engine constant, K_{gear} is a gear ratio, which may indicate the actuating torque as a function of position encoder current I. Furthermore, U corresponds to the voltage applied to the electromechanical position encoder drive of the position encoder system and φ corresponds to the instantaneous position of actuator 3 [sic; 2].

Challenges to modeling of a model equation which describes position encoder system 1 physically with the greatest possible accuracy include in particular the description of friction M_{f}(φ) and the description of restoring torque Mₛ(φ) exerted by a return spring for actuator 2 when the return spring has a nonlinear behavior.

Term A(pₚᵣₑ−pₚₒₛₜ) describes a torque exerted on actuator 2 by a pressure difference across actuator 2. In the case of a throttle valve having a central suspension, this term may be assumed to be 0 because the acting pressure acts equally on both halves of the throttle valve.

In contrast with previous physical modelings of position encoder systems, a detailed friction model, for example, a friction model according to Dahl, is used to describe the friction. It holds that:

$${M}_{f} ( \dot{ϕ} ) = {σ}_{0} z + D \dot{ϕ}$$

$$\dot{z} = \dot{ϕ} - \frac{{σ}_{0}}{{M}_{coul}} z \vert \dot{ϕ} \vert$$

where σ₀z is the nonlinear part. Alternatively, a distinction could also be made between static friction and dynamic friction.

With regard to the return spring, if the return spring has a spring constant which is nonlinear, depending on the deflection, i.e., position of actuator 2, this is taken into account. Return springs in throttle devices are typically provided with an elevated spring constant in the range of a zero to be able to ensure a reliable return to a certain basic position in the event of loss of a control torque. An example of the spring constant characteristic, i.e., the response of the return spring on actuator 2, is illustrated in the diagram in FIG. 2. In this regard it holds that:

Mₛ(φ)=Mₛₗᵢₙ(φ)+M_{sNL}(φ)

Mₛₗᵢₙ(φ)=Cₛφ

where Mₛₗᵢₙ(φ) corresponds to the linear part and M_{sNL}(φ) corresponds to the nonlinear part of the above differential equations describing the friction behavior. In the diagram in FIG. 2, Mₘₐₓ corresponds to the greatest possible restoring torque, Mₘᵢₙ corresponds to the lowest possible restoring torque, Φₘₐₓ corresponds to the maximum deflection of the return spring, M_{LHmin} determines the restoring torque at a disc angle Φ_{LHmin} and M_{LHmax} determines the restoring torque at a disc angle Φ_{LHmax}, where the spring characteristic has an increased slope between M_{LHmin} and M_{LHmax}.

In the description of above position encoder system 1, the friction model used as well as the model of the return spring having a nonlinear behavior both result in a nonlinear differential equation system.

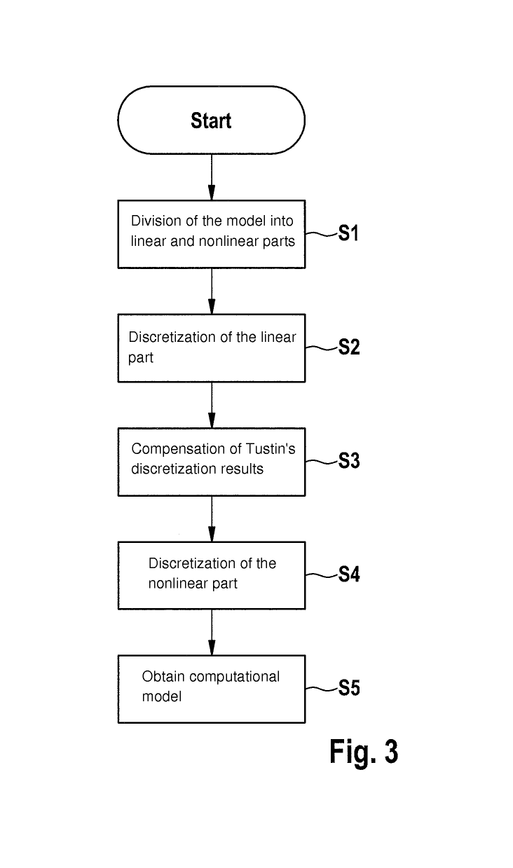

A method for a simplified solution of the nonlinear differential equation system is described below in conjunction with the flow chart in FIG. 3.

According to step S1 of the method, the model described by the nonlinear differential equation is divided into a linear part and a nonlinear part.

The following differential equation is obtained from the above equations:

$$U = \frac{LJ}{{C}_{m} {K}_{gear}} {ϕ}^{⃛} + \frac{RJ + LD}{{C}_{m} {K}_{gear}} \ddot{ϕ} + ( {C}_{m} {K}_{gear} + \frac{RD + {LC}_{s}}{{C}_{m} {K}_{gear}} ) \dot{ϕ} + \frac{{RC}_{s}}{{C}_{m} {K}_{gear}} ϕ + \frac{{RM}_{s NL} ( ϕ )}{{C}_{m} {K}_{gear}} + \frac{{RM}_{f NL} ( \dot{ϕ} )}{{C}_{m} {K}_{gear}} + \frac{RA ( {p}_{pre} - {p}_{post} )}{{C}_{m} {K}_{gear}}$$

A division into a linear part U* and a nonlinear part Uₙₒₙₗᵢₙₑₐᵣ yields:

$${U}^{*} = U - \frac{{RM}_{s NL} ( ϕ )}{{C}_{m} {K}_{gear}} - \frac{{RM}_{f NL} ( \dot{ϕ} )}{{C}_{m} {K}_{gear}} - \frac{RA ( {p}_{pre} - {p}_{post} )}{{C}_{m} {K}_{gear}}$$

$${U}^{*} = \frac{LJ}{{C}_{m} {K}_{gear}} {ϕ}^{⃛} + \frac{RJ + LD}{{C}_{m} {K}_{gear}} \ddot{ϕ} + ( {C}_{m} {K}_{gear} + \frac{RD + {LC}_{s}}{{C}_{m} {K}_{gear}} ) \dot{ϕ} + \frac{{RC}_{s}}{{C}_{m} {K}_{gear}} ϕ$$

The nonlinear part then corresponds to:

$${U}_{nicht\_linear} = - \frac{{RM}_{s NL} ( ϕ )}{{C}_{m} {K}_{gear}} - \frac{{RM}_{f NL} ( \dot{ϕ} )}{{C}_{m} {K}_{gear}} - \frac{RA ( {p}_{pre} - {p}_{post} )}{{C}_{m} {K}_{gear}}$$

In step S2, the linear part of the differential equation is then discretized according to a first discretization method. This may be carried out with the aid of Tustin's method. Tustin's transform is based on a Laplace transform and a transform corresponding to

$$s ← \frac{2}{dT} \frac{z - 1}{z + 1}$$

The Laplace transform is obtained from the linear differential equation:

$$\frac{Φ ( s )}{{U}^{*} ( s )} = \frac{1}{\frac{LJ}{{C}_{m} {K}_{gear}} {s}^{3} + \frac{RJ + LD}{{C}_{m} {K}_{gear}} {s}^{2} + ( {C}_{m} {K}_{gear} + \frac{RD + {LC}_{s}}{{C}_{m} {K}_{gear}} ) s + \frac{{RC}_{s}}{{C}_{m} {K}_{gear}}}$$

This yields Tustin's transform accordingly with

$$G ( s ) = \frac{1}{{as}^{3} + {bs}^{2} + cs + d}$$

$$and$$

$$s ← \frac{2}{dT} \frac{z - 1}{z + 1}$$

$$G ( z ) = \frac{α + 3 α {z}^{- 1} + 3 α {z}^{- 2} + α {z}^{- 3}}{1 + β {z}^{- 1} + γ {z}^{- 2} + δ {z}^{- 3}}$$

$$where \{ α , β , γ , δ \} = f ( a , b , c , d , dT )$$

$$with$$

$${a}_{1} = \frac{8 a}{{dT}^{3}}$$

$${b}_{1} = \frac{4 b}{{dT}^{2}}$$

$${c}_{1} = \frac{2 c}{dT}$$

$$α = \frac{1}{{a}_{1} + {b}_{1} + {c}_{1} + d}$$

$$β = α ( - 3 {a}_{1} - {b}_{1} + {c}_{1} + 3 d )$$

$$γ = α ( 3 {a}_{1} - {b}_{1} - {c}_{1} + 3 d )$$

$$δ = - γ - β - 1 + 8 α d$$

Tustin's discretization has the advantage that it results in computational models having simple calculation rules which may be calculated easily using microprocessors with only a comparatively low computing capacity. In particular the discretized computational model does not include any exponential equations or the like.

However, Tustin's discretization results in a leading of the discretization results which are compensated to improve the results. This compensation takes place in step S3 and may be carried out by providing an approximated delay of dT/2 according to

$$H ( z ) = \frac{z + 1}{2 z} = \frac{1 + {z}^{- 1}}{2}$$

It holds that:

$${u}_{1} ( {t}_{k} ) = {U}^{*} ( {t}_{k} ) + 3 {U}^{*} ( {t}_{k - 1} ) + 3 {U}^{*} ( {t}_{k - 2} ) + {U}^{*} ( {t}_{k - 3} )$$

$$\tilde{u} ( {t}_{k} ) = \frac{{u}_{1} ( {t}_{k} ) + {u}_{1} ( {t}_{k - 1} )}{2}$$

$$ϕ ( {t}_{k} ) = α \tilde{u} ( {t}_{k} ) - βϕ ( {t}_{k - 1} ) - γϕ ( {t}_{k - 2} ) - δϕ ( {t}_{k - 3} )$$

The nonlinear part of the above nonlinear differential equation is then discretized in step S4 according to a suitable second discretization method. In the present exemplary embodiment, the friction model and its nonlinear part described above are discretized. For example, an implicit discretization method such as the implicit Euler method may be used for this purpose:

$${M}_{f NL} ( \dot{ϕ} ( {t}_{k} ) ) = {σ}_{0} z ( {t}_{k} )$$

$$\dot{z} ( {t}_{k} ) = \frac{z ( {t}_{k} ) - z ( {t}_{k - 1} )}{dT}$$

$$\dot{z} ( {t}_{k} ) = \dot{ϕ} ( {t}_{k} ) - \frac{{σ}_{0}}{{M}_{coul}} z ( {t}_{k} ) \vert \dot{ϕ} ( {t}_{k} ) \vert$$

$$z ( {t}_{k} ) = \frac{\frac{z ( {t}_{k - 1} )}{dT} + \dot{ϕ} ( {t}_{k} )}{\frac{1}{dT} + \frac{{σ}_{0}}{{M}_{coul}} \vert \dot{ϕ} ( {t}_{k} ) \vert}$$

$${M}_{f NL} ( \dot{ϕ} ( {t}_{k} ) ) = {σ}_{0} z ( {t}_{k} )$$

$$\dot{ϕ} ( {t}_{k} ) = - \dot{ϕ} ( {t}_{k - 1} ) + \frac{2}{dT} ( ϕ ( {t}_{k} ) - ϕ ( {t}_{k - 1} ) )$$

$${u}^{*} ( {t}_{k} ) = u ( {t}_{k} ) - \frac{{RM}_{s NL} ( ϕ ( {t}_{k} ) )}{{C}_{m} {K}_{gear}} - \frac{{RM}_{f NL} ( \dot{ϕ} ( {t}_{k} ) )}{{C}_{m} {K}_{gear}} - \frac{RA}{{C}_{m} {K}_{gear}} ( {p}_{pre} - {p}_{post} )$$

In step S5 the discretized computational models of the discretized linear part and of the discretized nonlinear part of the differential equation system are combined to obtain the computational model for the position encoder system.

The discretization of the nonlinear friction model results in nonlinear equation components which often can no longer be solved mathematically. The computational model obtained above may then be solved by iterative methods.

To limit the computing effort, iteration limits are established which determine the range in which the iteration method is carried out. These iteration limits correspond to the extreme values of friction under the assumption that the spring torque is monotonic. It holds that:

−M_{coul}≦M_{f}_{_{NL}}(\dot{φ}(tₖ))≦M_{coul},

where M_{coul} corresponds to the torque exerted because of Coulomb friction.

$${\dot{ϕ}}_{min} \leq \dot{ϕ} ( {t}_{k} ) \leq {\dot{ϕ}}_{max}$$

$$where$$

$${\dot{ϕ}}_{min} = - {\dot{ϕ}}_{max}$$

$$ϕ ( {t}_{k} ) = ϕ ( {t}_{k - 1} ) + \frac{Δ t}{2} ( \dot{ϕ} ( {t}_{k} ) + \dot{ϕ} ( {t}_{k - 1} ) )$$

$$ϕ ( {t}_{k - 1} ) + \frac{Δ t}{2} ( - {\dot{ϕ}}_{max} + \dot{ϕ} ( {t}_{k - 1} ) ) \leq ϕ ( {t}_{k} ) \leq ϕ ( {t}_{k - 1} ) + \frac{Δ t}{2} ( {\dot{ϕ}}_{max} + \dot{ϕ} ( {t}_{k - 1} ) )$$

Since f:φ→M_{sNL}(φ) increases monotonically, it holds that

$$\underbrace{{M}_{s NL} ( ϕ ( {t}_{k - 1} ) + \frac{Δ t}{2} ( - {\dot{ϕ}}_{max} + \dot{ϕ} ( {t}_{k - 1} ) ) )}_{{M}_{s {NL}_{min}}} \leq {M}_{s NL} ( ϕ ( {t}_{k} ) ) \leq \underbrace{{M}_{s NL} ( ϕ ( {t}_{k - 1} ) + \frac{Δ t}{2} ( {\dot{ϕ}}_{max} + \dot{ϕ} ( {t}_{k - 1} ) ) )}_{{M}_{s {NL}_{max}}}$$

$$\frac{R ( {M}_{s NL min} - {M}_{coul} )}{{C}_{m} {K}_{gear}} \leq \frac{R ⌊ {M}_{s NL} ( ϕ ( {t}_{k} ) ) + {M}_{f NL} ( \dot{ϕ} ( {t}_{k} ) ) ⌋}{{C}_{m} {K}_{gear}} \leq \frac{R ( {M}_{s NL max} + {M}_{coul} )}{{C}_{m} {K}_{gear}}$$

If the starting values from the above equation are inserted into the starting differential equation, this yields a linear equation, the solution of which determines the interval in which the solution for the nonlinear equation is located. The nonlinear equation to be solved is solved iteratively by inclusion methods within this interval, which definitely limits the computing effort for determining the solution.

Alternatively, iteration limits may also be established by the second and n^{th} derivations of the position indication. It holds that:

$${\ddot{ϕ}}_{min} \leq \ddot{ϕ} ( {t}_{k} ) \leq {\ddot{ϕ}}_{max}$$

$$where$$

$${\ddot{ϕ}}_{min} = - {\ddot{ϕ}}_{max}$$

$$ϕ ( {t}_{k} ) = ϕ ( {t}_{k - 1} ) + \frac{Δ t}{2} ( \dot{ϕ} ( {t}_{k} ) + \dot{ϕ} ( {t}_{k - 1} ) )$$

$$\dot{ϕ} ( {t}_{k} ) = \dot{ϕ} ( {t}_{k - 1} ) + \frac{Δ t}{2} ( \ddot{ϕ} ( {t}_{k} ) + \ddot{ϕ} ( {t}_{k - 1} ) )$$

$$ϕ ( {t}_{k - 1} ) + Δ t \cdot \dot{ϕ} ( {t}_{k - 1} ) + \frac{Δ {t}^{2}}{4} ( - {\ddot{ϕ}}_{max} + \ddot{ϕ} ( {t}_{k - 1} ) ) \leq ϕ ( {t}_{k} ) \leq ϕ ( {t}_{k - 1} ) + Δ t \cdot \dot{ϕ} ( {t}_{k - 1} ) + \frac{Δ {t}^{2}}{4} ( {\ddot{ϕ}}_{max} + \ddot{ϕ} ( {t}_{k - 1} ) )$$

For the n^{th} derivation (for n≧2) it holds that

$${ϕ}_{min}^{( n )} \leq {ϕ}^{( n )} ( {t}_{k} ) \leq {ϕ}_{max}^{( n )}$$

$$where$$

$${ϕ}_{min}^{( n )} = - {ϕ}_{max}^{( n )}$$

$$ϕ ( {t}_{k - 1} ) + {\sum }_{i = 1}^{n - 1} [ \frac{Δ {t}^{k}}{{2}^{k - 1}} \cdot {ϕ}^{( k )} ( {t}_{k - 1} ) ] + {( \frac{Δ t}{2} )}^{n} ( - {ϕ}_{max}^{( n )} + {ϕ}^{( n )} ( {t}_{k - 1} ) ) \leq ϕ ( {t}_{k} ) \leq ϕ ( {t}_{k - 1} ) + {\sum }_{i = 1}^{n - 1} [ \frac{Δ {t}^{k}}{{2}^{k - 1}} \cdot {ϕ}^{( k )} ( {t}_{k - 1} ) ] + {( \frac{Δ t}{2} )}^{n} ( {ϕ}_{max}^{( n )} + {ϕ}^{( n )} ( {t}_{k - 1} ) )$$

$$n ε N , n ε [ 2 , + ∞ [$$

Mechatronic systems may be calculated efficiently and accurately using the above method.

What is claimed is:

1. A method for ascertaining a computational model for a position encoder system, comprising:
providing a differential equation system with at least one nonlinear term;
dividing the differential equation system to obtain a linear part which is describable by a linear differential equation and a nonlinear part which is describable by a nonlinear differential equation;
discretizing the linear part of the differential equation system in accordance with a first discretization method in order to obtain a computational model for the discretized linear part;
discretizing the nonlinear part of the differential equation system in accordance with a second discretization method in order to obtain a computational model for the discretized nonlinear part; and
combining the computational models of the discretized linear part and the discretized nonlinear part of the differential equation system to obtain the computational model for the position encoder system.

2. The method as recited in claim 1, wherein the at least one nonlinear term of the differential equation system is brought about at least one of by a friction and a static friction behavior of an actuator of the position encoder system and by a nonlinear characteristic line of a component of the position encoder system.

3. The method as recited in claim 1, wherein at least one of:
the first discretization method corresponds to Tustin's method, and
the second discretization method corresponds to an implicit method.

4. The method as recited in claim 1, wherein:
the first discretization method corresponds to Tustin's method, and
a leading in the computational model for the discretized linear part, resulting from Tustin's method, is compensated by taking into account a delay of dT/2.

5. The method as recited in claim 1, wherein the obtained computational model for the position encoder system is solved by an iterative method.

6. The method as recited in claim 5, further comprising:
determining an interval in which a solution of the obtained computational model for the position encoder system is located and the obtained computational model for the position encoder system is solved by the iterative method within the interval.

7. The method as recited in claim 1, wherein the position encoder system includes a position encoder for controlling a gas mass flow rate for an internal combustion engine.

8. A device for ascertaining a computational model for a position encoder system, comprising:
an arrangement for providing a differential equation system having at least one nonlinear term;
an arrangement for dividing a differential equation system to obtain a linear part which is describable by a linear differential equation and a nonlinear part which is describable by a nonlinear differential equation;
an arrangement for discretizing the linear part of the differential equation system in accordance with a first discretization method to obtain a computational model for the discretized linear part;
an arrangement for discretizing the nonlinear part of the differential equation system in accordance with a second discretization method to obtain a computational model for the discretized nonlinear part; and
an arrangement for combining the computational models of the discretized linear part and of the discretized nonlinear part of the differential equation system to obtain the computational model for the position encoder system.

9. The device as recited in claim 8, wherein the device includes an arithmetic unit.

10. The device as recited in claim 8, wherein the position encoder system includes a position encoder for controlling a gas mass flow rate for an internal combustion engine.

11. An engine system, comprising:
an internal combustion engine;
a position encoder system for adjusting a gas mass flow rate; and
a control unit for implementing a computational model for the position encoder system, the computational model being ascertained by:
providing a differential equation system with at least one nonlinear term,
dividing the differential equation system to obtain a linear part which is describable by a linear differential equation and a nonlinear part which is describable by a nonlinear differential equation,
discretizing the linear part of the differential equation system in accordance with a first discretization method in order to obtain a computational model for the discretized linear part,
discretizing the nonlinear part of the differential equation system in accordance with a second discretization method in order to obtain a computational model for the discretized nonlinear part, and
combining the computational models of the discretized linear part and the discretized nonlinear part of the differential equation system to obtain the computational model for the position encoder system.

12. A computer program executable on one of a computer and an arithmetic unit, the computer program having a program code to carry out the steps of:
providing a differential equation system with at least one nonlinear term;
dividing the differential equation system to obtain a linear part which is describable by a linear differential equation and a nonlinear part which is describable by a nonlinear differential equation;
discretizing the linear part of the differential equation system in accordance with a first discretization method in order to obtain a computational model for the discretized linear part;
discretizing the nonlinear part of the differential equation system in accordance with a second discretization method in order to obtain a computational model for the discretized nonlinear part; and
combining the computational models of the discretized linear part and the discretized nonlinear part of the differential equation system to obtain a computational model for a position encoder system.

13. A computer program product containing a program code stored on a computer-readable data medium that when executed on a data processing system carries out the steps of:
providing a differential equation system with at least one nonlinear term;
dividing the differential equation system to obtain a linear part which is describable by a linear differential equation and a nonlinear part which is describable by a nonlinear differential equation;
discretizing the linear part of the differential equation system in accordance with a first discretization method in order to obtain a computational model for the discretized linear part;
discretizing the nonlinear part of the differential equation system in accordance with a second discretization method in order to obtain a computational model for the discretized nonlinear part; and
combining the computational models of the discretized linear part and the discretized nonlinear part of the differential equation system to obtain a computational model for a position encoder system.
